(19) United States
(12) Patent Application Publication
(10) Pub. No.: US 2023/0214689 A1
(43) Pub. Date: Jul. 6, 2023

(54) METHOD AND APPARATUS FOR PROCESSING DIALOGUE, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xin TIAN, Beijing (CN); Yingzhan LIN, Beijing (CN); Mengfei SONG, Beijing (CN); Siqi BAO, Beijing (CN); Shiwei HUANG, Beijing (CN)

(21) Appl. No.: 18/121,053

(22) Filed: Mar. 14, 2023

(30) Foreign Application Priority Data
Sep. 2, 2022 (CN) 202211076682.5

(51) Int. Cl. G06N 5/04

(52) U.S. Cl. CPC G06N 5/04

(57) ABSTRACT

A method for processing a dialogue includes: obtaining a dialogue text of the dialogue, in which the dialogue text includes a current question text, or the dialogue text includes the current question text and a historical dialogue text; extracting a current query text from the dialogue text; obtaining a knowledge query result for the current query text by querying a knowledge database based on the current query text; and determining a response text for the current question text based on the knowledge query result and the dialogue text.

### CROSS-REFERENCE TO RELATED APPLICATION

This application claims priority and benefits to Chinese Application No. 202211076682.5, filed on Sep. 2, 2022, the entire content of which is incorporated herein by reference.

### TECHNICAL FIELD

The disclosure relates to a field of artificial intelligence technologies, especially fields of natural language processing, smart searching and deep learning technologies, in particular to a method for processing a dialogue, an apparatus for processing a dialogue, an electronic device and a storage medium.

### BACKGROUND

There are two main types of Task-Oriented Dialogue (TOD) systems, one is an end-to-end TOD system and the other is a streamline TOD system.

In the end-to-end TOD system, in a way of dialogue processing, historical dialogues and the whole database are encoded and put into the model. In an alternative way of dialogue processing, the historical dialogues and the whole database are used as input sequences.

### SUMMARY

According to the first aspect of the disclosure, a method for processing a dialogue is provided. The method includes: obtaining a dialogue text of the dialogue, in which the dialogue text includes a current question text, or the dialogue text includes a current question text and a historical dialogue text; extracting a current query text from the dialogue text; obtaining a knowledge query result for the current query text by querying a knowledge database based on the current query text; and determining a response text for the current question text based on the knowledge query result and the dialogue text.

According to the second aspect of the disclosure, an electronic device is provided. The electronic device includes:

at least one processor; and

a memory communicatively connected to the at least one processor; in which

the memory stores instructions executable by the at least one processor, and when the instructions are executed by the at least one processor, the at least one processor is caused to implement the method for processing a dialogue of the first aspect.

According to the third aspect of the disclosure, a non-transitory computer-readable storage medium having computer instructions stored thereon is provided. The computer instructions are configured to cause a computer to implement the method for processing a dialogue of the first aspect.

It is understandable that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram illustrating a first embodiment of the disclosure.

FIG. 2 is a schematic diagram illustrating a second embodiment of the disclosure.

FIG. 3 is a schematic diagram illustrating a third embodiment of the disclosure.

FIG. 4 is a schematic diagram illustrating a fourth embodiment of the disclosure.

FIG. 5 is a schematic diagram illustrating a query-driven TOD system.

FIG. 6 is a schematic diagram illustrating a fifth embodiment of the disclosure.

FIG. 7 is a schematic diagram illustrating a sixth embodiment of the disclosure.

FIG. 8 is a schematic diagram illustrating a seventh embodiment of the disclosure.

FIG. 9 is a block diagram illustrating an electronic device used to implement the embodiments of the disclosure.

### DETAILED DESCRIPTION

The following describes the embodiments of the disclosure with reference to the accompanying drawings, which includes various details of the embodiments of the disclosure to facilitate understanding, which shall be considered merely as examples. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Currently, the Task-Oriented Dialogue (TOD) system is oriented to vertical fields and aims to help users perform predefined tasks or actions using as few dialogue rounds as possible, such as booking airline tickets, scheduling, playing music, and route navigation. The TOD system generally relies on external databases to retrieve relevant knowledge to generate appropriate system replies.

In the related art, there are two main types of TOD systems, one is an end-to-end TOD system and the other is a streamline TOD system.

In the end-to-end TOD system, for an end-to-end trainable TOD system, the historical dialogues and the whole database are encoded and put into the model to implicitly learn a knowledge selecting capability through the memory network and the attention mechanisms, and then a final system response is generated through a decoder. For a pre-trained language model, some end-to-end models take the historical dialogues and the whole database as input sequences, and jointly input the input sequences into a transformer architecture, and the final system response can be directly obtained through decoding. In the former case, the end-to-end trainable TOD system needs to continuously update the model parameters, such that a heavy computational burden may be caused by the large-scale database and it is difficult to perform joint optimization. In the latter case, for the TOD system using the pre-trained language model, the input sequences tend to become too long to fit into the transformer structure due to the size of the database.

Several modules are learned sequentially in the streamline TOD system, such as, a natural language understanding model, a dialogue state tracking model, a dialogue policy learning model, and a system response generation model. The structured dialogue state query database is produced by the dialogue state tracking module and used for subsequent system response generation. The above scheme relies heavily on the predefined dialogue schema, which is strongly bound to the existing database and has poor capabilities of adapting to different fields.

With respect to the above problems, the disclosure provides a method for processing a dialogue, an apparatus for processing a dialogue, an electronic device and a storage medium.

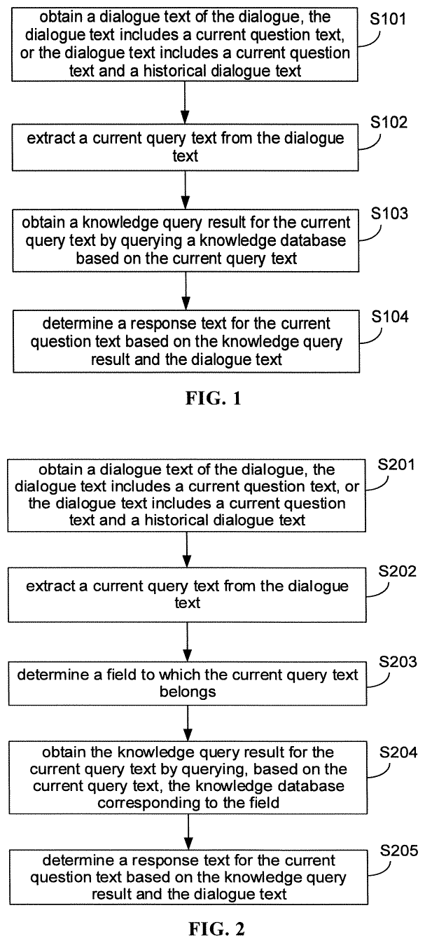

FIG. 1 is a schematic diagram illustrating a first embodiment of the disclosure. It is noteworthy that the method for processing a dialogue according to the embodiments of the disclosure can be performed by an apparatus for processing a dialogue. The apparatus can be contained in an electronic device or can be an electronic device, so that the electronic device can perform the function of processing a dialogue.

The electronic device may be any device having the computing capability, such as a Personal Computer (PC), a mobile terminal, and a server. The mobile terminal may be, for example, an in-vehicle device, a cell phone, a tablet computer, a personal digital assistant, a wearable device, and other hardware devices having various operating systems, touch screens, and/or displays.

As illustrated in FIG. 1, the method for processing a dialogue may include the following steps.

At step 101, a dialogue text of the dialogue is obtained, in which the dialogue text includes a current question text, or the dialogue text includes the current question text and a historical dialogue text.

For example, the current question text is “airline ticket from city A to city B tomorrow” and the historical dialogue text is “User: Check the airfare ticket for tomorrow. System: Where do you want to depart from? Where will you go?”. Therefore, the dialogue text can be “airline ticket from city A to city B tomorrow”, or the dialogue text can be “User: Check the airline ticket for tomorrow. System: Where do you want to depart from? Where will you go? User: From city A to city B tomorrow”.

At step 102, a current query text is extracted from the dialogue text.

In some embodiments, the electronic device can perform the step 102 by, for example, determining first prompt information and inputting the dialogue text and the first prompt information into the dialogue model to obtain the current query text outputted by the dialogue model by. The first prompt information is configured to prompt the dialogue model to extract the current query text;

For example, the dialogue text can be “I want to try to find an entertainment spot at city A”, and the current query text outputted by the dialogue model can be “find an entertainment spot at city A”.

By inputting both the dialogue text and the first prompt information into the dialogue model, the dialogue model can determine, based on the first prompt information, that a current task is extracting the current query text, such that the current query text can be outputted by the dialogue model, thereby ensuring the accuracy of the output from the dialogue model.

The model for obtaining the current query text and the model for determining the response text are the same dialogue model.

Using the same dialogue model to achieve two different functions of obtaining the current query text and determining the response text can reduce the number of model parameters and reduce costs, compared with using two dialogue models respectively to achieve two different functions.

In some embodiments, the network used to obtain the current query text is a query generation network contained in the dialogue model, and the electronic device can perform the step 102 by inputting the dialogue text into the query generation network to obtain the current query text outputted by the query generation network.

Obtaining the current query text through the query generation network does not need adding additional prompt information to distinguish current tasks of the dialogue model.

At step 103, a knowledge query result for the current query text is obtained by querying a knowledge database based on the current query text.

In embodiments of the disclosure, query texts in different fields respectively correspond to different knowledge databases, and the knowledge query result for the current query text is obtained by querying a knowledge database corresponding to the field to which the current query text belongs.

At step 104, a response text for the current question text is determined based on the knowledge query result and the dialogue text.

In some embodiments, the electronic device can perform the step 104 by, for example, determining second prompt information and inputting the knowledge query result, the dialogue text and the second prompt information into the dialogue model to obtain the response text output by the dialogue model. The second prompt information is configured to prompt the dialogue model to generate the response text.

By inputting both the dialogue text and the second prompt information into the dialogue model, the dialogue model can determine, based on the second prompt information, that the current task is generating the response text, such that the response text can be outputted by the dialogue model, thereby ensuring the accuracy of the output from the dialogue model.

In some embodiments, the network used to determine the response text is a response generation network contained in the dialogue model. The electronic device may perform the step 104 by inputting the knowledge query result and the dialogue text into the response generation network to obtain the response text outputted by the response generation network.

Obtaining the response text through the response generation network does not need adding additional prompt information to distinguish current tasks of the dialogue model.

With the method for processing a dialogue according to embodiments of the disclosure, the dialogue text of the dialogue is obtained. The dialogue text includes the current question text or the dialogue text includes the current question text and the historical dialogue text. The current query text is extracted from the dialogue text. The knowledge query result for the current query text is obtained by querying the knowledge database based on the current query text. The response text for the current question text is determined based on the knowledge query result and the dialogue text. Therefore, decoupling of obtaining the knowledge query result and generating the response text is realized, and there is no need to encode the knowledge database and put the encoded knowledge database to the dialogue model or input the knowledge database into the dialogue model. The knowledge database is used with the current query text only during the querying, thereby improving the capabilities of adapting to different fields.

In order to accurately obtain the knowledge query result for the current query text according to the current query text, the field to which the current query text belongs may be determined firstly, and the knowledge query result for the current query text is obtained by querying the knowledge database corresponding to the field to which the current query text belongs based on current query text, as illustrated in FIG. 2 which is a schematic diagram illustrating a second embodiment of the disclosure. The embodiment illustrated in FIG. 2 may include the following.

At step 201, a dialogue text of the dialogue is obtained. The dialogue text includes a current question text or the dialogue text includes the current question text and a historical dialogue text.

At step 202, a current query text is extracted from the dialogue text.

At step 203, a field to which the current query text belongs is determined.

For example, if the current query text is “song of Singer As”, the electronic device can determine, based on the content of the current query text, that the field to which the current query text belongs is music. If the current query text is “What day is the Christmas Day”, the electronic device can determine, based on the current query text, that the field to which current query text belongs is holiday.

At step 204, the knowledge query result for the current query text is obtained by querying, based on the current query text, the knowledge database corresponding to the field to which the current query text belongs.

There is a plurality of knowledge databases, and the plurality of knowledge databases respectively correspond to different fields.

In some embodiments, the electronic device can perform the step 204 by, for example, obtaining a search result based on the current query text by querying, based on the current query text, the knowledge database corresponding to the field to which the current query text belongs; obtaining a sorting result by sorting, based on respective correlations between a plurality of knowledge records contained in the search result and the current query text, the plurality of knowledge records in a descending order; and determining a preset number of knowledge records that are ranked first in the sorting result as the knowledge query result for the current query text.

For example, if the current query text is “songs of Singer A”, the field to which the current query text belongs, i.e., the music field, is queried based on current query text. The search result for “songs of Singer A” is obtained by querying the knowledge database corresponding to the music field. Based on the respective correlations between the knowledge records in the search result and “songs of Singer A”, the knowledge records are sorted in a descending order to obtain the sorting result, and the top 10 knowledge records in the sorting result are determined as the knowledge query result for “songs of Singer A”.

The preset number of knowledge query results for the current query text can be set according to the actual needs, such as 10 or 20, which is not limited here.

By querying, based on the current query text, the knowledge database corresponding to the field to which the current query text belongs to obtain the search result, storing the knowledge records in the search result based on the correlations between the knowledge records and the current query text to obtain the sorting result, and determining the preset number of knowledge records in the sorting result as the knowledge query result, the correlation of the knowledge query result to the current query text is improved and the knowledge query result is more in line with user requirements, thereby improving the capabilities of adapting to different fields.

At step 205, a response text for the current question text is determined based on the knowledge query result and the dialogue text.

It is noteworthy that the details of step 201, step 202, and step 205 can refer to step 101, step 102, and step 104 in the embodiment illustrated in FIG. 1, which will not be described in detail here.

With the method for processing a dialogue according to embodiments of the disclosure, the dialogue text of the dialogue is obtained. The dialogue text includes the current question text or the dialogue text includes the current question text and the historical dialogue text. The current query text is extracted from the dialogue text. The field to which the current query text belongs is determined. The knowledge query result for the current query text is obtained by querying the knowledge database corresponding to the field to which the current query text belongs. Therefore, decoupling of obtaining the knowledge query result and generating the response text is realized, and there is no need to encode the knowledge database and put the encoded knowledge database to the dialogue model or input the encoded knowledge database into the dialogue model. The knowledge database is used with the current query text only during the querying, thereby improving the capabilities of adapting to different fields.

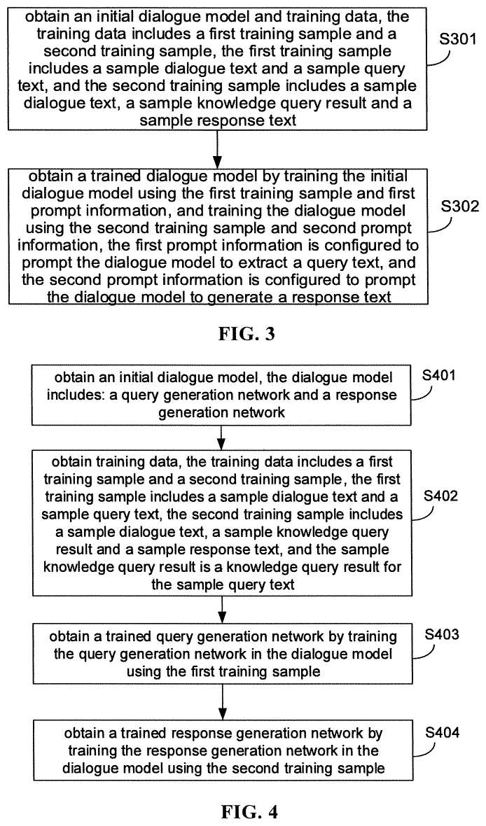

FIG. 3 is a schematic diagram illustrating a third embodiment of the disclosure. As illustrated in FIG. 3, the method for training a dialogue model includes the following.

At step 301, an initial dialogue model and training data are obtained. The training data includes a first training sample and a second training sample. The first training sample includes a sample dialogue text and a sample query text. The second training sample includes a sample dialogue text, a sample knowledge query result and a sample response text.

The sample knowledge query result is the knowledge query result for the sample query text.

At step 302, a trained dialogue model is obtained by training the initial dialogue model using the first training sample and first prompt information, and training the dialogue model using the second training sample and second prompt information. The first prompt information is configured to prompt the dialogue model to extract a query text, and the second prompt information is configured to prompt the dialogue model to generate a response text.

The process of training the initial dialogue model using the first training sample and the first prompt information and the process of training the dialogue model using the second training sample and the second prompt information can be performed simultaneously, and the execution order is not limited.

The same dialogue model can perform two different functions of obtaining the current query text and determining the response text.

In conclusion, the initial dialogue model and the training data are obtained. The training data includes the first training sample and the second training sample. The first training sample includes the sample dialogue text and the sample query text, and the second training sample includes the sample dialogue text, the sample knowledge query result and the sample response text. The trained dialogue model is obtained by training the initial dialogue model based on the first training sample and the first prompt information and training the dialogue model based on the second training sample and the second prompt information. The first prompt information is configured to prompt the dialogue model to extract the query text, and the second prompt information is configured to prompt the dialogue model to generate the response text. Therefore, decoupling of obtaining the knowledge query result and generating the response text is realized. Instead of encoding the knowledge database and putting the encoded knowledge database to the dialogue model or inputting the encoded knowledge database into the dialogue model, the knowledge database is used with the current query text only during the querying, thereby improving the capabilities of adapting to different fields.

FIG. 4 is a schematic diagram illustrating a fourth embodiment of the disclosure. As illustrated in FIG. 4, the method for training a dialogue model includes the following.

At step 401, an initial dialogue model is obtained. The dialogue model includes: a query generation network and a response generation network.

The query generation network and the response generation network can be the same network or different networks.

At step 402, training data is obtained. The training data includes a first training sample and a second training sample. The first training sample includes a sample dialogue text and a sample query text. The second training sample includes a sample dialogue text, a sample knowledge query result and a sample response text. The sample knowledge query result is a knowledge query result for the sample query text.

At step 403, a trained query generation network is obtained by training the query generation network in the dialogue model using the first training sample.

At step 404, a trained response generation network is obtained by training the response generation network in the dialogue model using the second training sample.

In conclusion, the initial dialogue model is obtained. The dialogue model includes the query generation network and the response generation network. The training data including the first training sample and the second training sample is obtained. The first training sample includes the sample dialogue text and the sample query text. The second training sample includes the sample dialogue text, the sample knowledge query result and the sample response text. The sample knowledge query result is a knowledge query result for the sample query text. The trained query generation network is obtained by training the query generation network in the dialogue model using the first training sample. The trained response generation network is obtained by training the response generation network in the dialogue model using the second training sample. Therefore, decoupling of obtaining the knowledge query result and generating the response text is realized. Instead of encoding the knowledge database and putting the encoded knowledge database to the dialogue model or inputting the encoded knowledge database into the dialogue model, the knowledge database is used with the current query text only during the querying, thereby improving the capabilities of adapting to different fields.

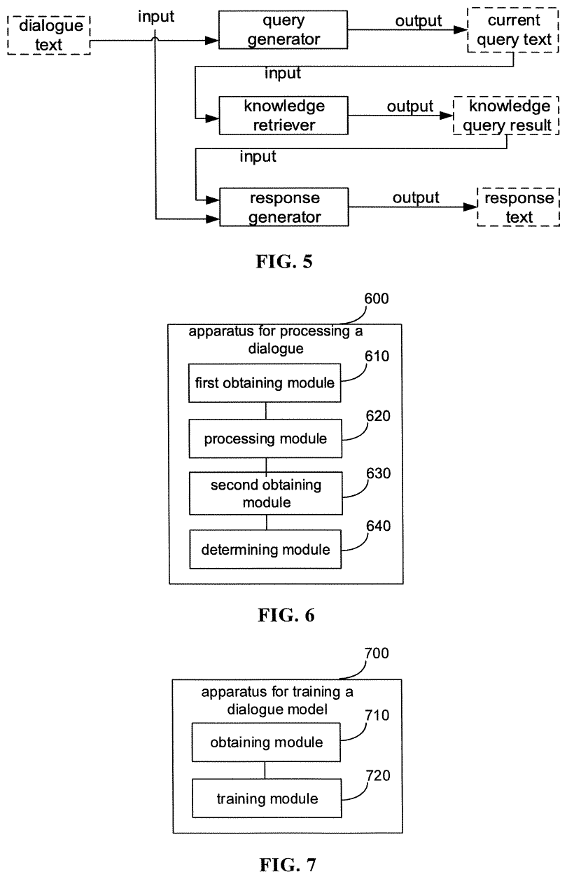

For example, FIG. 5 is a schematic diagram illustrating a Query-driven TOD (Q-TOD) system, as illustrated in FIG. 5, the Q-TOD system may include three modules, i.e., a query generator, a knowledge retriever and a response generator. (1) The dialogue text is input into the query generator to obtain the current query text, i.e., Query, outputted by the query generator. The current query text is in the unstructured format of natural language and is not limited to those included in existing databases. (2) The current query text is input into an existing knowledge retriever, such that the knowledge retriever retrieves relevant top k knowledge records from the knowledge database based on the generated current query text, determines, from the top k knowledge records, K knowledge records as the knowledge query result for the current query text and outputs the result, in which the respective correlations between the K knowledge records and the generated current query text are the highest. (3) The knowledge query result and the dialogue text are input into the response generator, such that the response generator generates a final response text based on the retrieved knowledge query result and the dialogue text and outputs the final response text.

The query generator and the response generator are jointly trained by the pre-trained language model using the transformer architecture. The query generator and the response generator share model parameters and the training can be performed for multiple tasks by means of prompts. The knowledge retriever can be any retrieval tool or model that does not have to be trained, such as Best Matching25 (BM25), ElasticSearch, and RocketQA, which is not limited here.

In conclusion, the dialogue text is input into the query generator to obtain the current query text outputted by the query generator. The current query text is input into the existing knowledge retriever to obtain the knowledge query result outputted by the knowledge retriever. The knowledge query result and the dialogue text are input into the response generator to obtain the response text outputted by the response generator. Therefore, decoupling of obtaining the knowledge query result and generating the response text is realized, and there is no need to encode the knowledge database and put the encoded knowledge database to the dialogue model or input the knowledge database into the dialogue model. The knowledge database is used with the current query text only during the querying, thereby improving the capabilities of adapting to different fields.

In order to realize the above embodiments, the disclosure also provides an apparatus for processing a dialogue.

As illustrated in FIG. 6, FIG. 6 is a schematic diagram illustrating a fifth embodiment of the disclosure. The apparatus 600: a first obtaining module 610, a processing module 620, a second obtaining module 630, and a determining module 640.

The first obtaining module 610 is configured to obtain a dialogue text of the dialogue. The dialogue text includes a current question text or the dialogue text includes the current question text and a historical dialogue text.

The processing module 620 is configured to extract a current query text from the dialogue text.

The second obtaining module 630 is configured to obtain a knowledge query result for the current query text by querying, based on the current query text, a knowledge database.

The determining module 640 is configured to determine a response text for the current question text based on the knowledge query result and the dialogue text.

As a possible implementation, a model for obtaining the current query text and a model for determining the response text are the same dialogue model.

As a possible implementation, the processing module 620 is further configured to: determine first prompt information, and obtain the current query text outputted by the dialogue model by inputting the dialogue text and the first prompt information into the dialogue model. The first prompt information is configured to prompt the dialogue model to extract the current query text.

As a possible implementation, the determining module 640 is further configured to: determine second prompt information, and obtain the response text outputted by the dialogue model by inputting the knowledge query result, the dialogue text and the second prompt information into the dialogue model. The second prompt information is configured to prompt the dialogue model to generate the response text.

As a possible implementation, a network for obtaining the current query text is a query generation network contained in the dialogue model, and a network for determining the response text is a response generation network contained in the dialogue model. The processing module 620 is further configured to: obtain the current query text outputted by the query generation network by inputting the dialogue text into the query generation network. The determining module 640 is further configured to: obtain the response text outputted by the response generation network by inputting the knowledge query result and the dialogue text into the response generation network.

As a possible implementation, there are more than one knowledge database. The knowledge databases respectively correspond to different fields. The second obtaining module 630 is further configured to: determine a field to which the current query text belongs; and obtain the knowledge query result for the current query text by querying, based on the current query text, the knowledge database corresponding to the field to which the current query text belongs.

As a possible implementation, the second obtaining module 630 is further configured to: obtain a search result based on the current query text by querying, based on the current query text, the knowledge database corresponding to the field to which the current query text belongs; obtain a sorting result by sorting, based on respective correlations between a plurality of knowledge records contained in the search result and the current query text, the plurality of knowledge records in a descending order; and determine a preset number of knowledge records that are ranked first in the sorting result as the knowledge query result for the current query text.

In order to realize the above embodiments, the disclosure also provides an apparatus for training a dialogue model.

As illustrated in FIG. 7 which is a schematic diagram illustrating a sixth embodiment of the disclosure, the apparatus 700 for training a dialogue model includes: an obtaining module 710 and a training module 720.

The obtaining module 710 is configured to obtain an initial dialogue model and training data. The training data includes a first training sample and a second training sample. The first training sample includes a sample dialogue text and a sample query text. The second training sample includes a sample dialogue text, a sample knowledge query result and a sample response text. The training module 720 is configured to obtain a trained dialogue model by training the initial dialogue model using the first training sample and first prompt information and training the dialogue model using the second training sample and second prompt information. The first prompt information is configured to prompt the dialogue model to extract a query text. The second prompt information is configured to prompt the dialogue model to generate a response text.

In order to realize the above embodiments, the disclosure also provides an apparatus for training a dialogue model.

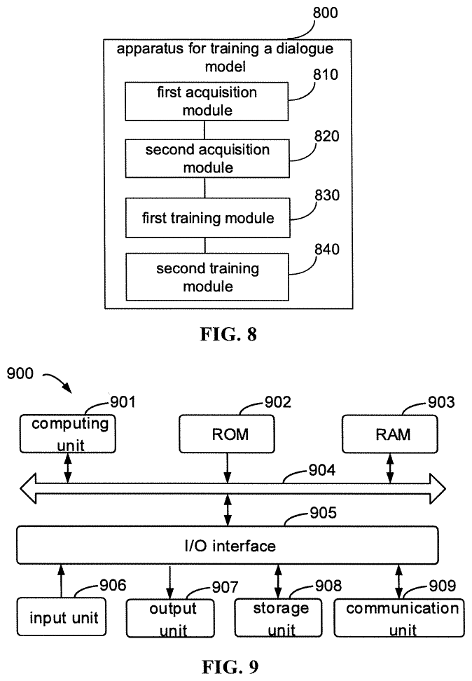

As illustrated in FIG. 8 which is a schematic diagram illustrating a seventh embodiment of the disclosure, the apparatus 800 for training a dialogue model includes: a first acquisition module 810, a second acquisition module 820, a first training module 830, and a second training module 840.

The first acquisition module 810 is configured to obtain an initial dialogue model. The dialogue model includes: a query generation network and a response generation network. The second acquisition module 820 is configured to obtain training data. The training data includes a first training sample and a second training sample. The first training sample includes a sample dialogue text and a sample query text. The second training sample includes a sample dialogue text, a sample knowledge query result and a sample response text. The sample knowledge query result is a knowledge query result for the sample query text. The first training module 830 is configured to obtain a trained query generation network by training the query generation network in the dialogue model using the first training sample. The second training module 840 is configured to obtain a trained response generation network by training the response generation network in the dialogue model using the second training sample.

The collection, storage, use, processing, transmission, provision and disclosure of the user's personal information involved in the technical solutions of this disclosure are carried out with the consent of the user, and all comply with the provisions of relevant laws and regulations and are not contrary to public order and morality.

According to the embodiments of the disclosure, the disclosure also provides an electronic device, a readable storage medium and a computer program product.

FIG. 9 is a block diagram of an example electronic device 900 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the device 900 includes a computing unit 901 performing various appropriate actions and processes based on computer programs stored in a Read-Only Memory (ROM) 902 or computer programs loaded from a storage unit 908 to a Random Access Memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an input unit 906, such as a keyboard, a mouse; an output unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of the computing unit 901 include, but are not limited to, a Central Processing Unit (CPU), a Graphics Processing Unit (GPU), various dedicated AI computing chips, various computing units that run ML model algorithms, and a Digital Signal Processor (DSP), and any appropriate processor, controller and microcontroller. The computing unit 901 executes the various methods and processes described above, such as, a method for processing a dialogue, a method for training a dialogue model, or another method for training a dialogue model. For example, in some embodiments, the method for processing a dialogue, the method for training a dialogue model, or the another method for training a dialogue model may be implemented as computer software programs, which are tangibly contained in a machine-readable medium, such as the storage unit 908. In some embodiments, part or all of the computer programs may be loaded and/or installed on the device 900 via the ROM 902 and/or the communication unit 909. When the computer programs are loaded on the RAM 903 and executed by the computing unit 901, one or more steps of the method for processing a dialogue, the method for training a dialogue model, or the another method for training a dialogue model described above may be executed. Alternatively, in other embodiments, the computing unit 901 may be configured to perform the method for processing a dialogue, the method for training a dialogue model, or the another method for training a dialogue model in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server may be a cloud server, a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for processing a dialogue, comprising:
obtaining a dialogue text of the dialogue, wherein the dialogue text comprises a current question text, or the dialogue text comprises a current question text and a historical dialogue text;
extracting a current query text from the dialogue text;
obtaining a knowledge query result for the current query text by querying a knowledge database based on the current query text; and
determining a response text for the current question text based on the knowledge query result and the dialogue text.

2. The method of claim 1, further comprising:
using a same dialogue model for obtaining the current query text and determining the response text.

3. The method of claim 2, wherein extracting the current query text from the dialogue text comprises:
determining first prompt information, wherein the first prompt information is configured to prompt the dialogue model to extract the current query text; and
obtaining the current query text outputted by the dialogue model by inputting the dialogue text and the first prompt information into the dialogue model.

4. The method of claim 2, wherein determining the response text for the current question text based on the knowledge query result and the dialogue text comprises:
determining second prompt information, wherein the second prompt information is configured to prompt the dialogue model to generate the response text; and
obtaining the response text outputted by the dialogue model by inputting the knowledge query result, the dialogue text and the second prompt information into the dialogue model.

5. The method of claim 2, wherein the dialogue model includes a query generation network for obtaining the current query text and a response generation network for determining the response text;
wherein extracting the current query text from the dialogue text comprises: obtaining the current query text outputted by the query generation network by inputting the dialogue text into the query generation network; and
wherein determining the response text for the current question text based on the knowledge query result and the dialogue text comprises: obtaining the response text outputted by the response generation network by inputting the knowledge query result and the dialogue text into the response generation network.

6. The method of claim 1, wherein there are more than one knowledge database, and the knowledge databases respectively correspond to different fields; and
wherein obtaining the knowledge query result for the current query text by querying the knowledge database based on the current query text comprises:
determining a field to which the current query text belongs; and
obtaining the knowledge query result for the current query text by querying, based on the current query text, the knowledge database corresponding to the field to which the current query text belongs.

7. The method of claim 6, wherein obtaining the knowledge query result for the current query text by querying, based on the current query text, the knowledge database corresponding to the field to which the current query text belongs comprises:
obtaining a search result based on the current query text by querying, based on the current query text, the knowledge database corresponding to the field to which the current query text belongs;
obtaining a sorting result by sorting, based on respective correlations between a plurality of knowledge records contained in the search result and the current query text, the plurality of knowledge records in a descending order; and
determining a preset number of knowledge records that are ranked first in the sorting result as the knowledge query result for the current query text.

8. The method of claim 2, wherein the dialogue model is obtained by training an initial dialogue model using a first training sample and first prompt information and training the initial dialogue model using a second training sample and second prompt information,
wherein the first training sample comprises a sample dialogue text and a sample query text, the second training sample comprises a sample dialogue text, a sample knowledge query result and a sample response text, and the sample knowledge query result is a knowledge query result for the sample query text; and
wherein the first prompt information is configured to prompt the dialogue model to extract a query text, and the second prompt information is configured to prompt the dialogue model to generate a response text.

9. The method of claim 8, wherein the initial dialogue model comprises a query generation network and a response generation network; and
wherein a trained query generation network is obtained by training the query generation network in the dialogue model using the first training sample; and a trained response generation network is obtained by training the response generation network in the dialogue model using the second training sample.

10. An electronic device, comprising:
at least one processor; and
a memory communicatively connected to the at least one processor; wherein
the memory stores instructions executable by the at least one processor, and when the instructions are executed by the at least one processor, the at least one processor is configured to:
obtain a dialogue text of the dialogue, wherein the dialogue text comprises a current question text, or the dialogue text comprises a current question text and a historical dialogue text;
extract a current query text from the dialogue text;
obtain a knowledge query result for the current query text by querying a knowledge database based on the current query text; and
determine a response text for the current question text based on the knowledge query result and the dialogue text.

11. The electronic device of claim 10, wherein the at least one processor is further configured to:
use a same dialogue model for obtaining the current query text and determining the response text.

12. The electronic device of claim 11, wherein the at least one processor is configured to:
determine first prompt information, wherein the first prompt information is configured to prompt the dialogue model to extract the current query text; and
obtain the current query text outputted by the dialogue model by inputting the dialogue text and the first prompt information into the dialogue model.

13. The electronic device of claim 11, wherein the at least one processor is configured to:
determine second prompt information, wherein the second prompt information is configured to prompt the dialogue model to generate the response text; and
obtain the response text outputted by the dialogue model by inputting the knowledge query result, the dialogue text and the second prompt information into the dialogue model.

14. The electronic device of claim 11, wherein the dialogue model includes a query generation network for obtaining the current query text and a response generation network for determining the response text;
wherein the at least one processor is configured to:
obtain the current query text outputted by the query generation network by inputting the dialogue text into the query generation network; and
obtain the response text outputted by the response generation network by inputting the knowledge query result and the dialogue text into the response generation network.

15. The electronic device of claim 10, wherein there are more than one knowledge database, and the knowledge databases respectively correspond to different fields; and
the at least one processor is configured to:
determine a field to which the current query text belongs; and
obtain the knowledge query result for the current query text by querying, based on the current query text, the knowledge database corresponding to the field to which the current query text belongs.

16. The electronic device of claim 15, wherein the at least one processor is configured to:
obtain a search result based on the current query text by querying, based on the current query text, the knowledge database corresponding to the field to which the current query text belongs;
obtain a sorting result by sorting, based on respective correlations between a plurality of knowledge records contained in the search result and the current query text, the plurality of knowledge records in a descending order; and
determine a preset number of knowledge records that are ranked first in the sorting result as the knowledge query result for the current query text.

17. The electronic device of claim 11, wherein the dialogue model is obtained by training an initial dialogue model using a first training sample and first prompt information and training the initial dialogue model using a second training sample and second prompt information,
wherein the first training sample comprises a sample dialogue text and a sample query text, the second training sample comprises a sample dialogue text, a sample knowledge query result and a sample response text, and the sample knowledge query result is a knowledge query result for the sample query text; and
wherein the first prompt information is configured to prompt the dialogue model to extract a query text, and the second prompt information is configured to prompt the dialogue model to generate a response text.

18. The electronic device of claim 17, wherein the initial dialogue model comprises a query generation network and a response generation network; and
wherein a trained query generation network is obtained by training the query generation network in the dialogue model using the first training sample; and a trained response generation network is obtained by training the response generation network in the dialogue model using the second training sample.

19. A non-transitory computer-readable storage medium, having computer instructions stored thereon, wherein when the computer instructions are performed by a processor, the processor is configured to:
obtain a dialogue text of the dialogue, wherein the dialogue text comprises a current question text, or the dialogue text comprises a current question text and a historical dialogue text;
extract a current query text from the dialogue text;
obtain a knowledge query result for the current query text by querying a knowledge database based on the current query text; and
determine a response text for the current question text based on the knowledge query result and the dialogue text.

20. The non-transitory computer-readable storage medium of claim 19, wherein the processor is further configured to:
use a same dialogue model for obtaining the current query text and determining the response text.
